(19) United States
(12) Patent Application Publication
(10) Pub. No.: US 2005/0082983 A1
(43) Pub. Date: Apr. 21, 2005

(54) High-pressure discharge lamp

(76) Inventors: Rolf Theo Anton Apetz, Aachen (DE); Ton Reiner Mulderij, Eindhoven (NL); Lucas Johannes Anna Maria Beckers, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/501,165

(22) PCT Filed: Dec. 20, 2002
(86) PCT No.: PCT/IB02/05683

(30) Foreign Application Priority Data
Jan. 15, 2002 (EP) 02075147.5

(51) Int. Cl. H01J 17/18; H01J 61/36

(52) U.S. Cl. 313/623; 313/625

(57) ABSTRACT

The invention relates to a high-pressure discharge lamp having a discharge vessel (10) with a ceramic wall (1) which is closed at one end by a plug. The plug (2) is provided with an electrode (3) arranged in the discharge vessel (10). The ceramic wall (1) and the plug (2) are jointed by a fusion joint (4). The fusion joint (4) comprises an alloy comprising substantially molybdenum and aluminum. Preferably, the fusion joint (4) comprises a material selected from the group formed by Al₈Mo₃, Al₆₃Mo₃₇, Al₃Mo₃₇, AlMo, AlMo₃ and combinations of said materials. Preferably, the plug (2) comprises a material selected from the group formed by molybdenum, 1 tungsten and combinations of said materials. Preferably, the ceramic wall (1) comprises aluminum nitride. According to the invention, the plug (2) has a high corrosion resistance.

The invention relates to a high-pressure discharge lamp provided with a discharge vessel with a ceramic wall which is closed at one end by a plug provided with an electrode arranged in the discharge vessel, the ceramic wall and the plug being jointed by a fusion joint.

Examples of such lamps are high intensity discharge lamps, for instance metal halide lamps. Such lamps are widely used in practice and have a high luminous efficacy with good color properties.

A lamp of the kind mentioned in the opening paragraph is known in the art. The fusion joint provides a gastight connection of the plug to the ceramic wall by means of a melting glass fusion joint.

It was found to be a disadvantage of the known lamp that the melting glass fusion joint itself appears to be vulnerable to attacks by filling ingredients from the discharge vessel during lamp life. This gives rise to leaks in the course of time, which results in the end of the lamp life.

A ceramic wall in the present description and claims is understood to be a wall made from one of the following materials: monocrystalline metal oxide (for example sapphire), densely sintered polycrystalline metal oxide (for example Al₂O₃, YAG), and densely sintered polycrystalline metal nitride (for example AlN).

The invention has for an object to provide a means for counteracting the above disadvantage. According to the invention, a discharge lamp of the kind mentioned in the opening paragraph is for this purpose characterized in that the fusion joint comprises an alloy comprising substantially molybdenum and aluminum.

It is an advantage of the lamp according to the invention that the use of melting glass can be dispensed with. It is indeed possible to form the fusion joint between the plug and the ceramic wall from an alloy comprising substantially molybdenum and aluminum. The fusion joint is made into a hermetically closed seal by means of a suitable sintering process which is known per se.

In an advantageous embodiment of the lamp according to the invention, the fusion joint comprises at least 25 atom percent Mo. An advantage of using such a fusion joint is that the melting temperature of said alloys is well above 1500° C. Said melting temperatures are well above the burning temperature of the lamp (approximately 1200° C.), are comparable to typical sealing temperatures during lamp manufacturing (approximately 1600° C.) and are well below the melting temperature of the ceramic tube.

In a further advantageous embodiment of the lamp according to the invention, the fusion joint comprises a material selected from the group formed by Al₈Mo₃, Al₆₃Mo₃₇, Al₆₃Mo₃₇, AlMo, AlMo₃ and combinations of said materials. Al₈Mo₃ and Al₆₃Mo₃₇ from this group have the lowest melting temperatures, i.e. in the range from approximately 1570-1580° C. The melting temperature of the other alloys are above 1700° C. The preferred alloys are stable with regard to pressure and chemical attack by the lamp filling during operation of the discharge lamp.

In an advantageous embodiment of the lamp according to the invention, the plug comprises a material selected from the group formed by molybdenum, tungsten and combinations of said materials. An advantage is that the plug is electrically conducing and therefore the electrode can be welded directly to the plug. In the known lamp the ceramic wall of the discharge vessel is closed off at an end by means of a projecting plug through which a lead-through construction extends from an end of the projecting plug to an electrode positioned in the discharge vessel. The discharge lamp according to the invention has a simple design. This means a simplification in lamp manufacture, which is a considerable improvement in mass production on an industrial scale.

In an advantageous embodiment of the lamp according to the invention, the ceramic wall comprises aluminum nitride. AlN has a higher chemical resistance towards lamp fillings at high temperatures and a high thermal conductivity as compared to the ceramic walls in the known discharge lamps. The higher temperature conductivity results in a more homogeneous temperature distribution, giving rise to better color property, in particular an improved color rendering.

Preferably, the high-pressure discharge lamp is a metal halide lamp. The invention is favorable, in particular, for lamps having a comparatively high power rating, for example of 100 W or more.

The above and further aspects of the invention will be explained in more detail with reference to a drawing, in which:

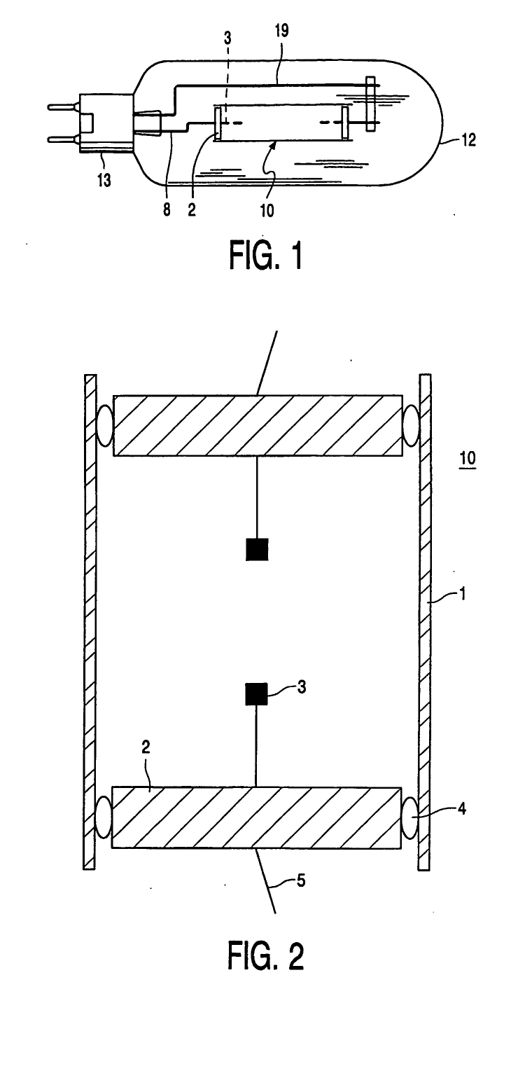

FIG. 1 diagrammatically shows a discharge lamp according to the invention, and

FIG. 2 shows the discharge vessel of the lamp of FIG. 1.

The Figures are purely diagrammatic and not drawn true to scale. Some dimensions are particularly strongly exaggerated for reasons of clarity. Like components have been given like reference numerals as much as possible in the Figures.

FIG. 1 shows a high-pressure discharge lamp provided with a discharge vessel 10 with a ceramic wall which is closed off at both ends by means of a plug 2. In a practical embodiment of the lamp, the discharge vessel contains at least one metal halide in addition to Hg and a rare gas.

The discharge vessel 10 is surrounded by an outer envelope 12 which is provided with a lamp cap 13 at one end. In the operational state of the lamp, a discharge extends between the electrodes. One of the electrodes 3 is connected to a first electrical contact point forming part of the lamp cap 13 via a current conductor 18. Similarly, the other electrode is connected to a second electrical contact point of the lamp cap 13 via a current conductor 19.

The discharge vessel 10 is depicted not true to scale in FIG. 2. The discharge vessel 10 is provided with a ceramic wall 1 which is closed off at least at one end by means of a plug 2. The plug 2 is provided with an electrode 3 positioned in the discharge vessel. In the example of FIG. 2, the plug 2 is made of a Mo/W alloy comprising 70/30 weight % Mo/W (standard product), from which massive plugs were made. In the example of FIG. 2, the ceramic wall 1 is made of aluminum nitride (AlN). The wall material and the plug material practically have the same expansion coefficient.

The ceramic wall 1 of the discharge vessel is manufactured as follows. Before kneading the AlN was mixed with holmiumoxide and coated with stearine acid, to avoid the reaction of AlN with water. After coating, the AlN was mixed with a binder and water and kneaded into a proper kneading mass in a vacuum kneader. After extruding AlN from the kneading mass, the AlN was dried, cut in the desired lengths and finally calcinated in oxygen.

Currently, most ceramic discharge lamps are made of PCA (poly crystalline alumina). This material exhibits certain limitations concerning the maximum load and strength. Aluminum nitride (AlN) ceramic properties differ significantly from PCA. The main differences between PCA and AlN are the higher chemical resistance towards CDM lamp fillings at high temperatures and the much better thermal conductivity (about six times better than PCA) which result in better overall thermo-mechanical properties for AlN.

According to the invention, the ceramic wall 1 and the plug 2 are jointed by a fusion joint 4. The fusion joint 4 comprises an alloy comprising substantially molybdenum and aluminum. The fusion joint 4 preferably comprises 25-80 atom percent molybdenum, the remainder comprising substantially aluminum. Preferably, the fusion joint 4 comprises a material selected from the group formed by Al₈Mo₃, Al₆₃Mo₃₇, Al₆₃Mo₃₇, AlMo, AlMo₃ and combinations of said materials. Al₈Mo₃ and Al₆₃Mo₃₇ from this group have the lowest melting temperatures. The melting temperature of Al₈Mo₃ is approximately 1577° C. The melting temperature of Al₆₃Mo₃₇ is approximately 1570° C. The melting temperatures of the other alloys are approximately 1757° C. for AlMo and approximately 2150° C. (±100° C.) for AlMo₃. In preparing the fusion joint, rings of the selected composition of the two aluminum and molybdenum metal powders were made which fitted around the plug. After applying these rings over the plugs, the plugs were inserted into a high-frequency coil and heated until the rings melted. During manufacturing of the discharge vessel, plugs provided with the so-obtained rings were inserted into green ceramic tubes and during sintering at approximately 1830° C. the ceramic wall shrank around the plugs and the fusion joint created a leak proof connection. Sintering was carried out in a N₂/H₂ atmosphere.

In a practical embodiment of the lamp, the discharge vessel 1 contains a filling consisting of 0.6 mg of Hg, 1.5 mg of iodides of Na, and Ta, for instance a filling of 2.2 mg of NaI (88%) and TaI (12%), and Ar with a filling pressure of 50 mbar. In a practical realization of the discharge lamp described, the lamp has a power rating of 150 W.

The electrode 3 provided with an electrode tip facing towards the discharge space, is made of W and is fastened to the plug 2. The discharge applies itself to the electrode tip when the lamp is in the operational state. Because the plugs are electrically conducting, it is sufficient to weld the electrode 3 to the Mo/W plug, for instance by means of laser welding or resistance welding. This is a technique where the two conducting parts are pressed together after which a strong current is passed through them. An advantage is that the parts are welded together over their entire contact surface. Molybdenum pins 5 are welded to the side of the plug 2 facing away from the electrode 3.

In an alternative embodiment of the high-pressure discharge lamp, a Mo rod is used as current feedthrough which extends through the plug connecting the molybdenum pin to the electrode.

The scope of protection of the invention is not limited to the embodiments given by way of example here. The invention is defined by each novel characteristic and all combinations of characteristics. Reference numerals in the claims do not limit the scope of protection thereof. The use of forms of the verb “comprise” does not exclude the presence of elements other than those mentioned in the claims. The use of the indefinite article “a” and “an” preceding an element does not exclude the possibility of a plurality of such elements being present.

1. A high-pressure discharge lamp provided with a discharge vessel (10) with a ceramic wall (1) which is closed at one end by a plug (2) provided with an electrode (3) arranged in the discharge vessel, the ceramic wall (1) and the plug (2) being jointed by a fusion joint (4), characterized in that
the fusion joint (4) comprises an alloy comprising substantially molybdenum and aluminum.

2. A high-pressure discharge lamp as claimed in claim 1, characterized in that the fusion joint (4) comprises at least 25 atom percent Mo.

3. A high-pressure discharge lamp as claimed in claim 2, characterized in that the fusion joint (4) comprises a material selected from the group formed by Al8Mo3, Al63Mo37, Al63Mo37, AlMo, AlMo₃ and combinations of said materials.

4. A high-pressure discharge lamp as claimed in claim 1, characterized in that the plug (2) comprises a material selected from the group formed by molybdenum, tungsten and combinations of said materials.

5. A high-pressure discharge lamp as claimed in claim 1, characterized in that the ceramic wall (1) comprises aluminum nitride.

6. A high-pressure discharge lamp as claimed in claim 1, characterized in that the lamp is a metal halide lamp.

7. A high-pressure discharge lamp as claimed in claim 1, characterized in that the lamp has a power rating of at least 100 W.
